(19) United States
(12) Patent Application Publication
(10) Pub. No.: US 2009/0280387 A1
(43) Pub. Date: Nov. 12, 2009

(54) Fuel Mixing Apparatus and Fuel Cell System Using the Same

(75) Inventors: CHARN-YING CHEN, Taoyuan County (TW); DER-HSING LIOU, Taoyuan County (TW); CHUN-LUNG CHANG, Taoyuan County (TW); HOU-CHIN CHA, Taoyuan County (TW); SUN-MEI LIN, Taoyuan County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Institute of Nuclear Energy Research Atomic Energy Council, Executive Yuan

(21) Appl. No.: 12/166,570

(22) Filed: Jul. 2, 2008

(30) Foreign Application Priority Data
May 6, 2008 (TW) 097116598

(51) Int. Cl. H01M 2/00

(52) U.S. Cl. 429/34

(57) ABSTRACT

The present invention discloses a fuel mixing apparatus, comprising: a container capable of accommodating a fuel and comprising a first inlet, a second inlet, a first outlet and a second outlet; and a tank floating on the fuel inside the container, comprising a pair of openings and communicating with the second inlet and the second outlet through flexible tubes respectively. In addition, the present invention further provides a fuel cell system combing the fuel mixing apparatus and a fuel cell module. When the fuel cell system is tilted, the tank of the fuel mixing apparatus is capable of adjusting its location in accordance with the surface of the fuel, while the flexible tubes are still capable of keeping an unhindered passage for the gas and/or the liquid to enter or to be exhausted from the container smoothly.

### BACKGROUND OF THE INVENTION

1. Field of the Invention

The present invention generally relates to a fuel processing technique and, more particularly, to a fuel mixing apparatus and a fuel cell system using the fuel mixing apparatus. The fuel mixing apparatus contains a mixture of a fuel and a liquid and is capable of exhausting waste gas.

2. Description of the Prior Art

A fuel cell is a new-generation power generating device that uses electro-chemical reactions between hydrogen or alcohol and oxygen to transform chemical energy into electrical energy. Since the fossil fuels will be used up in decades, the fuel cell has become one of the most promising alternatives. Generally, the fuel cell is used in vehicles (such as electric cars, electric motorcycles and electric bicycles) to replace conventional internal combustion engines that consume gasoline or diesel. More particularly, the fuel cell provides direct-current (DC) as a power source for the vehicles and has attracted tremendous attention.

The size of an improved fuel cell is reduced so that the fuel cell is widely used as a power supply in various portable electronic appliances such as notebooks, personal digital assistants (PDA's) and global positioning systems (GPS's). However, when these portable electronic appliances are shaken while being carried or used, they are not able to be kept at a certain angle.

Please refer to Taiwan Pat. Pub. No. M292790 entitled “Fuel Cell System with Parameter Adjustment Capability”, in which the reaction products are collected by a liquid-gas separator to exhaust unnecessary carbon dioxide (CO₂) and delivers the collected mixture of methanol and water back to a mixer to complete a recycle system. In this case, if the angle of the fuel cell is changed when the fuel cell installed on a portable electronic appliance is shaken while being carried or used to cause the change of liquid surface in the liquid-gas separator and block the gas from entering and being exhausted, the waste gas cannot be exhausted and the collected mixture of methanol and water cannot be returned back to the mixer.

Moreover, Japanese Patent Laid-Open Publication No. 2004-186151 discloses a fuel fixing container, in which the problem due to the change of angle of the fuel cell is overcome. However, in this technique, the gas and the liquid are not separated and therefore the fuel may be carried away by the exhausted waste gas.

Therefore, there is need in providing a fuel processing technique to overcome the aforesaid problem and therefore the fuel cell installed in a portable electronic appliance can be used even when the portable electronic appliance is shaken while being carried or used.

### SUMMARY OF THE INVENTION

It is an object of the present invention to provide a fuel mixing apparatus and a fuel cell system using the fuel mixing apparatus, wherein the fuel mixing apparatus is designed to use a mixture comprising a fuel and a liquid and is capable of exhausting waste gas. Moreover, in order to be installed on a portable electronic appliance, the fuel mixing apparatus comprises a plurality of flexible tubes between a container and a tank. In this manner, when the liquid surface of the liquid fuel in the container changes, the tank is capable of adjusting its location in accordance with the surface of the fuel so that the flexible tubes are capable of keeping an unhindered passage for the gas and/or the liquid to enter or to be exhausted from the container smoothly.

It is another object of the present invention to provide to a fuel mixing apparatus and a fuel cell system using the fuel mixing apparatus, wherein the fuel is prevented from being carried away by the gas to reduce the loss of fuel due to liquid-gas separation.

It is still another object of the present invention to provide a fuel mixing apparatus and a fuel cell system using the fuel mixing apparatus, wherein the processing device for reaction products is integrated to down-size the fuel cell due to liquid-gas separation and non-direction characteristics.

In order to achieve the foregoing objects, in one embodiment, the present invention provides a fuel mixing apparatus, comprising: a container capable of accommodating a fuel and comprising a first inlet, a second inlet, a first outlet and a second outlet; and a tank floating on the fuel inside the container, comprising a pair of openings and communicating with the second inlet and the second outlet through flexible tubes respectively.

In another embodiment, the present invention further provides fuel cell system, comprising: a fuel cell module comprising an anode zone and a cathode zone; and a fuel mixing apparatus coupled to the fuel cell module and comprising: a container capable of accommodating a fuel and coupled to the anode zone through a first inlet and a first outlet and coupled to the cathode zone through a second inlet, the container further comprising a second outlet; and a tank floating on the fuel inside the container, comprising a pair of openings and communicating with the second inlet and the second outlet through flexible tubes respectively.

### BRIEF DESCRIPTION OF THE DRAWINGS

The objects, spirits and advantages of the preferred embodiments of the present invention will be readily understood by the accompanying drawings and detailed descriptions, wherein:

FIG. 1A is a schematic diagram of a fuel mixing apparatus according to a first embodiment of the present invention;

FIG. 1B is a schematic diagram of a fuel mixing apparatus according to a second embodiment of the present invention;

FIG. 2 is a schematic diagram of a fuel cell system according to the present invention;

FIG. 3 shows the fuel mixing apparatus in FIG. 1A being tilted; and

FIG. 4 shows the fuel cell system in FIG. 2 being tilted.

### DETAILED DESCRIPTION OF THE PREFERRED EMBODIMENT

The present invention can be exemplified but not limited by the embodiments as described hereinafter.

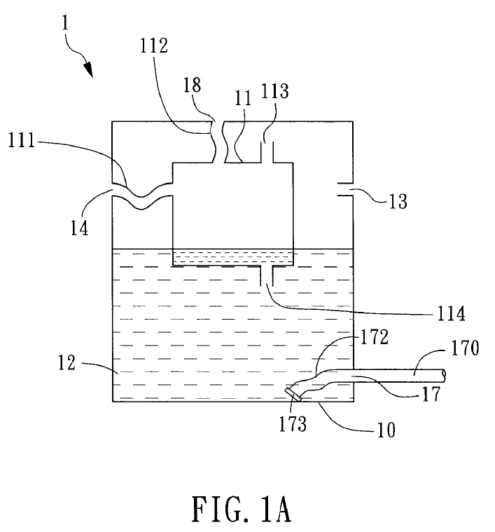

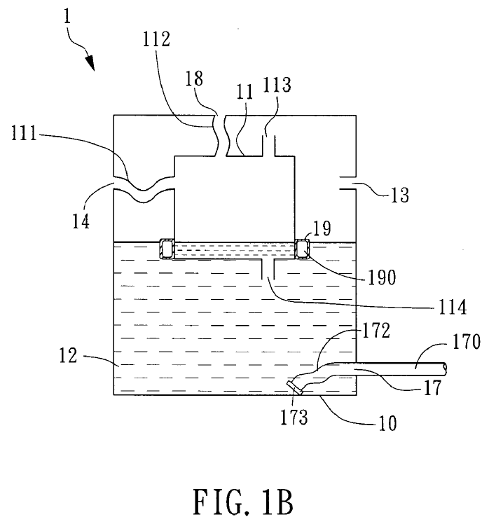

Please refer to FIG. 1A, which is a schematic diagram of a fuel mixing apparatus according to a first embodiment of the present invention. The fuel mixing apparatus 1 comprises a container 10 and a tank 11. The container 10 is capable of accommodating a fuel 12. The fuel 12 can be a liquid-phase hydrogen-rich fuel. For example, the liquid-phase hydrogen-rich fuel is a mixture comprising an alcohol and a liquid. In the present embodiment, the liquid can be water or the like. The alcohol is methanol or ethanol, and is not restricted thereof. The container 10 comprises a first inlet 13, a second inlet 14, a first outlet 17 and a second outlet 18. The tank 11 is floating on the fuel 12 inside the container 10. The density of the material of the tank 11 is smaller than that of the fuel 12. The tank 11 communicates with the second inlet 14 through a first flexible tube 111 and with the second outlet 18 through a second flexible tube 112. The first outlet 17 is coupled to a pipe 170 outside the container 10 and is coupled to a flexible pipe 172 inside the container 10.

To make sure that the flexible pipe 172 is kept oriented towards the gravity direction when the angle of the container 10 changes, a counterweight 173 is further disposed at a front end of the flexible pipe 172. The first flexible tube 111 and the second flexible tube 112 are metal flexible tubes or silicone flexible tubes and are not restricted thereto, as long as they are flexible. In another embodiment, as shown in FIG. 1B, a floating body 19 is further disposed around the tank 11 to assist the tank 11 to float on the fuel 12. Essentially, the floating body can be implemented using conventional technique, and thus description thereof is not repeated. Generally, the floating body can be a closed object filled with gas 190 and disposed around the tank 11.

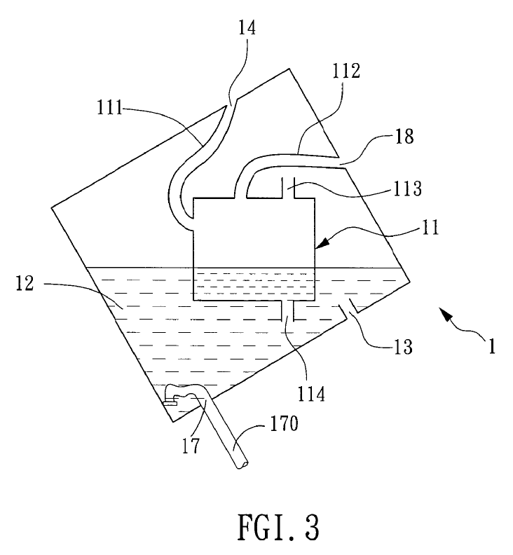

Please refer to FIG. 3, which shows the fuel mixing apparatus in FIG. 1A being tilted. The liquid surface of the fuel 12 changes as the container 10 is tilted. Meanwhile, the position of the tank 11 also changes because the tank 11 is kept floating on the fuel 12. Since the first flexible tube 111 and the second flexible tube 112 are flexible, their shapes change according to the position of the tank 11 to keeping an unhindered passage therein for the gas and/or the liquid to enter or to be exhausted from the container smoothly when the position of the tank 11 changes. The tank 11 further comprises a first opening 113 and a second opening 114. Therefore, one of the first and the second openings 113 and 114 is exposed to the gas, while the other receives the fuel when the container 10 is positioned at any angle (for example, being tilted or upside down). The flexible pipe 172 inside the first outlet 17 can always receive the fuel 12 because of the counterweight 173 even when the container 10 is tilted. For example, in FIG. 3, the first opening 113 is exposed to the gas and the second opening 114 receives the fuel.

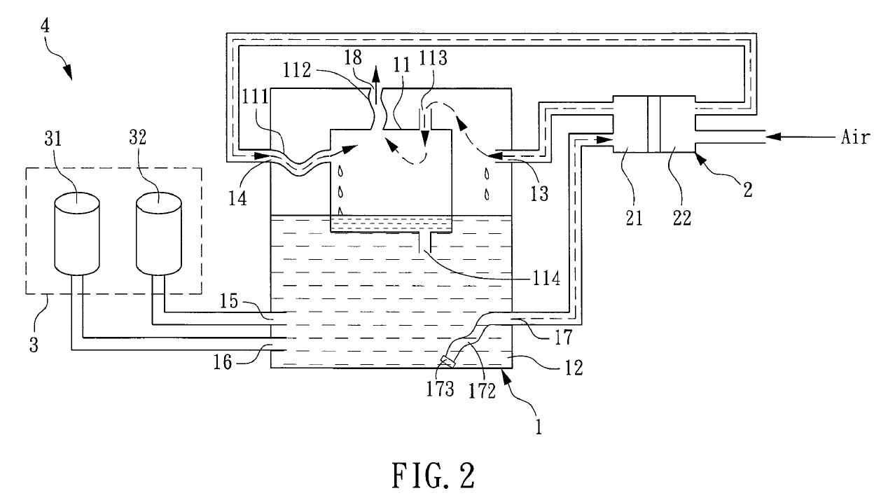

Please refer to FIG. 2, which is a schematic diagram of a fuel cell system using the fuel mixing apparatus in FIG. 1A according to the present invention. The fuel cell system 4 comprises a fuel cell module 2, a liquid-phase fuel supply unit 3 and a fuel mixing apparatus 1. The fuel cell module 2 comprises an anode zone 21 and a cathode zone 22. The fuel cell system 4 can also comprise a plurality of fuel cell modules connected in parallel or in series. The fuel cell module 2 can be implemented using conventional technique, and thus description thereof is not repeated. The fuel mixing apparatus 1 is connected to the liquid-phase fuel supply unit 3 and the fuel cell module 2. The fuel mixing apparatus 1 comprises a container 10 and a tank 11. The container 10 is capable of accommodating a fuel 12. The fuel 12 can be a liquid-phase hydrogen-rich fuel. For example, the liquid-phase hydrogen-rich fuel is a mixture comprising an alcohol and a liquid. In the present embodiment, the liquid can be water or the like. The alcohol is methanol or ethanol. The alcohol and the liquid are supplied by a liquid-phase fuel supply unit 3 comprising a fuel supply unit 31 capable of storing the alcohol and a liquid supply unit 32 capable of storing the liquid. The container 10 further comprises a third inlet 15 and a fourth inlet 16 coupled respectively the liquid supply unit 32 and the fuel supply unit 31 to supply the alcohol and the liquid to the container 10 to be mixed to form the liquid fuel 12.

The container 10 is coupled to the anode zone 21 through a first inlet 13 and a first outlet 17. The first outlet 17 is used to supply the fuel to the anode zone 21. The waste after reaction in the anode zone 21 is guided to the container 10 through the first inlet 13. The waste after reaction in the anode zone 21 comprises residual un-reacted fuel and reacted product such as carbon dioxide. The residual un-reacted fuel flows into the container 10, while carbon dioxide enters the tank 11 through the first opening 113 and is then exhausted through the second outlet 18. More particularly, the second outlet 18 is capable of exhausting unnecessary gas, which comprises carbon dioxide in the anode zone and reacted gas in the cathode zone. The container 10 is further coupled to the cathode zone 22 through a second inlet 14 so that the produced water and reacted gas in the cathode zone 22 are guided to enter the container 10 through the second inlet 14. The water is then mixed with the fuel 12, while the gas produced in the cathode zone 22 is exhausted through the second outlet 18. Therefore, the fuel mixing apparatus is capable of recycling the fuel and exhausting the waste gas.

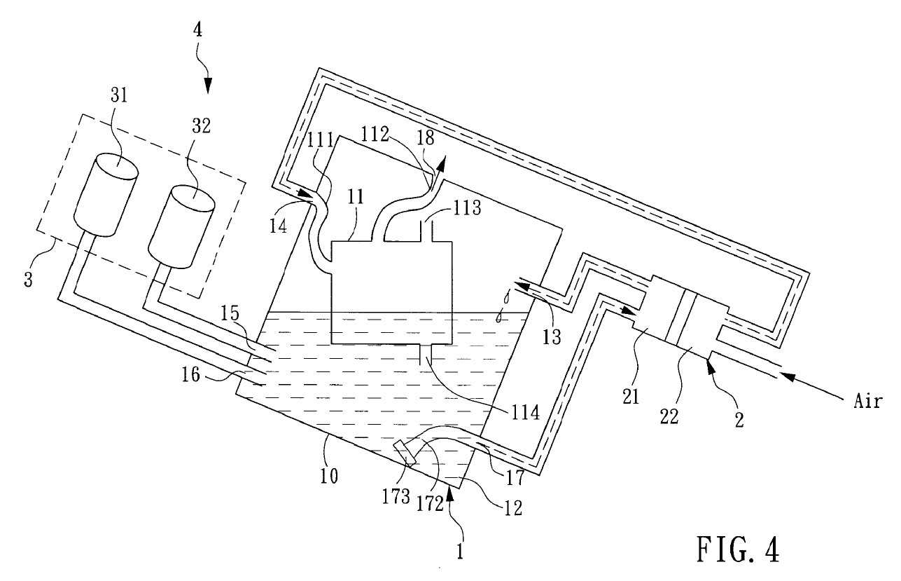

Please refer to FIG. 4, which shows the fuel cell system in FIG. 2 being tilted. In the present embodiment, the fuel cell system in FIG. 2 is tilted by an angle. The position of the tank 11 in the fuel mixing apparatus 1 changes because the tank 11 is kept floating on the fuel 12. Since the first flexible tube 111 and the second flexible tube 112 are flexible, their shapes change according to the position of the tank 11 to keeping an unhindered passage therein for the gas and/or the liquid to enter or to be exhausted from the container smoothly when the position of the tank 11 changes.

From FIG. 1A to FIG. 4, it is understood that the present invention discloses a fuel mixing apparatus and a fuel cell system using the fuel mixing apparatus, wherein the fuel mixing apparatus is designed to use a mixture comprising a fuel and a liquid and is capable of exhausting waste gas. Moreover, in order to be installed on a portable electronic appliance, the fuel mixing apparatus comprises a plurality of flexible tubes between a container and a tank. In this manner, when the liquid surface of the liquid fuel in the container changes, the tank is capable of adjusting its location in accordance with the surface of the fuel so that the flexible tubes are capable of keeping an unhindered passage for the gas and/or the liquid to enter or to be exhausted from the container smoothly.

According to the above discussion, it is apparent that the present invention discloses a fuel processing technique to overcome the problem in the prior art and therefore the fuel cell installed in a portable electronic appliance can be used even when the portable electronic appliance is shaken while being carried or used. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A fuel mixing apparatus, comprising:
a container capable of accommodating a fuel and comprising a first inlet, a second inlet, a first outlet and a second outlet; and
a tank floating on the fuel inside the container, comprising a pair of openings and communicating with the second inlet and the second outlet through flexible tubes respectively.

2. The fuel mixing apparatus as recited in claim 1, wherein the fuel is a liquid-phase hydrogen-rich fuel.

3. The fuel mixing apparatus as recited in claim 2, wherein the liquid-phase hydrogen-rich fuel is a mixture comprising an alcohol and a liquid.

4. The fuel mixing apparatus as recited in claim 3, wherein the liquid is water.

5. The fuel mixing apparatus as recited in claim 3, wherein the alcohol is methanol or ethanol.

6. The fuel mixing apparatus as recited in claim 1, wherein the flexible tubes are metal flexible tubes or silicone flexible tubes.

7. The fuel mixing apparatus as recited in claim 1, wherein the first outlet is connected to a flexible pipe at an opening of the container.

8. The fuel mixing apparatus as recited in claim 7, further comprising a counterweight disposed at a front end of the flexible pipe.

9. The fuel mixing apparatus as recited in claim 1, further comprising a floating body disposed around the tank.

10. A fuel cell system, comprising:
a fuel cell module comprising an anode zone and a cathode zone; and
a fuel mixing apparatus coupled to the fuel cell module and comprising:
a container capable of accommodating a fuel and coupled to the anode zone through a first inlet and a first outlet and coupled to the cathode zone through a second inlet, the container further comprising a second outlet; and
a tank floating on the fuel inside the container, comprising a pair of openings and communicating with the second inlet and the second outlet through flexible tubes respectively.

11. The fuel cell system as recited in claim 10, wherein the fuel is a liquid-phase hydrogen-rich fuel.

12. The fuel cell system as recited in claim 11, wherein the liquid-phase hydrogen-rich fuel is a mixture comprising an alcohol and a liquid.

13. The fuel cell system as recited in claim 12, wherein the liquid is water.

14. The fuel cell system as recited in claim 12, wherein the alcohol is methanol or ethanol.

15. The fuel cell system as recited in claim 10, wherein the container further comprises a third inlet and a fourth inlet being connected to a liquid-phase fuel supply unit.

16. The fuel cell system as recited in claim 15, wherein the liquid-phase fuel supply unit further comprises a fuel supply unit and a liquid supply unit.

17. The fuel cell system as recited in claim 10, wherein the flexible tubes are metal flexible tubes or silicone flexible tubes.

18. The fuel cell system as recited in claim 10, wherein the second outlet is capable of exhausting unnecessary gas.

19. The fuel cell system as recited in claim 18, wherein the unnecessary gas comprises carbon dioxide in the anode zone and reacted gas in the cathode zone.

20. The fuel cell system as recited in claim 10, wherein the first outlet is connected to a flexible pipe at an opening of the container.

21. The fuel cell system as recited in claim 20, further comprising a counterweight disposed at a front end of the flexible pipe.

22. The fuel cell system as recited in claim 10, further comprising a floating body disposed around the tank.
